(19) United States
(12) Patent Application Publication
(10) Pub. No.: US 2024/0300353 A1
(43) Pub. Date: Sep. 12, 2024

(54) CHARGING AND DISCHARGING FACILITY

(71) Applicant: TOYOTA JIDOSHA KABUSHIKI KAISHA, Aichi-ken (JP)

(72) Inventors: Takuji MATSUBARA, Aichi-ken (JP); Osamu YUMITA, Aichi-ken (JP); Naoki HASEGAWA, Aichi-ken (JP); Sa KANO, Aichi-ken (JP)

(21) Appl. No.: 18/586,539

(22) Filed: Feb. 26, 2024

(30) Foreign Application Priority Data
Mar. 7, 2023 (JP) 2023-034918

(51) Int. Cl. B60L 53/30; B60L 53/18; B60L 53/20; E04H 6/08

(52) U.S. Cl. CPC B60L 53/30; B60L 53/18; B60L 53/20; E04H 6/08

(57) ABSTRACT

The charging and discharging facility has a first level section where the first charging and discharging parking space is located, a second level section where the second charging and discharging parking space is located on the floor directly above the first level section, and a power converter device connected between the first level section and the second level section by an external power cable. In the first charging and discharging parking space, the first charging and discharging connection member is attached to the end of the first charging and discharging cable extending from the ceiling of the first level section, and in the second charging and discharging parking space, the second charging and discharging connection member is attached to the end of the second charging and discharging cable extending from the floor of the second level section.

### CROSS-REFERENCE TO RELATED APPLICATION

The present disclosure claims priority to Japanese Patent Application No. 2023-034918 filed on Mar. 7, 2023, which is incorporated herein by reference in its entirety including specification, drawings and claims.

### TECHNICAL FIELD

This disclosure relates to the charging and discharging facility, and in particular, to the charging and discharging facility for charging and discharging batteries mounted on vehicles parked in a parking space.

### BACKGROUND

As a conventional charging and discharging facility of is type, a charging stand equipped with a movable part that shifts from a state of being stored under the ground to an exposed state above the ground when the charging connector is withdrawn has been proposed (see, for example, Patent Document 1). In this charging stand, the man-hours required to start charging are reduced by shifting the movable part from a state in which it is stored under the ground to a state in which it is exposed above the ground.

### CITATION LIST

### Patent Literature

PTL 1: JP2022-154290

### SUMMARY

The parking lots of facilities such as airports may be multi-story parking buildings or multi-story underground parking facilities, as well as above ground. It is also contemplated to meet the electric demand of the facility by charging and discharging the batteries of electric vehicles parked in the parking lots. For these reasons, it is necessary to efficiently arrange the charging and discharging facility in the parking lots.

The main purpose of the charging and discharging facility of this disclosure is to make charging and discharging facility in multi-story parking garages more efficient.

The charging and discharging facility of the present disclosure has adopted the following measures to achieve the main objectives described above.

The charging and discharging facility of the present disclosure equipped with:
a first level section in which a first charging and discharging parking space is located for charging and discharging a battery mounted on a vehicle;
a second level section which is a floor directly above the first level section arranged such that a second charging and discharging parking space for charging and discharging a battery mounted on the vehicle is located directly above the first charging and discharging parking space; and
a power converter device located between the first level section and the second level section and connected to the outside world by a power cable; wherein
in the first charging and discharging parking space, a first charging and discharging connection member that is chargeable and dischargeable with a vehicle-side connection for charging and discharging the battery of a parked vehicle is attached to the end of a first charging and discharging cable that is connected to the power converter device and extends from a ceiling of the first level section; and
in the second charging and discharging parking space, a second charging and discharging connection member that is chargeable and dischargeable with a vehicle-side connection for charging and discharging the battery of the parked vehicle is attached to the end of a second charging and discharging cable that is connected to the power converter device and extends from a floor of the second level section.

The charging and discharging facility of the present disclosure equipped with a first level section in which a first charging and discharging parking space is located for charging and discharging a battery mounted on a vehicle, a second level section which is a floor directly above the first level section arranged such that a second charging and discharging parking space for charging and discharging a battery mounted on the vehicle is located directly above the first charging and discharging parking space, and a power converter located between the first level section and the second level section and connected to the outside world by a power cable. And wherein in the first charging and discharging parking space, a first charging and discharging connection member that is chargeable and dischargeable with the vehicle-side connection for charging and discharging the battery of the parked vehicle is attached to the end of the first charging and discharging cable that is connected to the power converter device and extends from a ceiling of the first level section, and in the second charging and discharging parking space, a second charging and discharging connection member that is chargeable and dischargeable with the vehicle-side connection for charging and discharging the battery of the parked vehicle is attached to the end of the second charging and discharging cable that is connected to the power converter device and extends from the floor of the second level section. Therefore, in the charging and discharging facility of the present disclosure, for vehicles parked in the first charging and discharging parking space of the first level section, charging and discharging is performed using the first charging and discharging connection member attached to the end of the first charging and discharging cable that extends from the ceiling, and for vehicles parked in the second charging and discharging parking space on the second level section, charging and discharging is performed using the second charging and discharging connection member attached to the end of the second charging and discharging cable that extends from the floor. As a result, the charging and discharging facility can be made more efficient than those that use charging and discharging connection members attached to the ends of charging and discharging cable extending from the floor or ceiling for vehicles parked in the charging and discharging parking spaces on each level section.

### BRIEF DESCRIPTION OF DRAWINGS

FIG. 1 shows a schematic configuration of the charging and discharging facility 20 as one embodiment of this disclosure.

FIG. 2 shows an illustration of an example of the arrangement of the second charging and discharging parking space 48 on the second floor of the charging and discharging facility 20.

FIG. 3 shows a schematic configuration of the vehicle that can use each of the charging and discharging parking spaces 38, 48.

FIG. 4 shows an illustration of an example of the arrangement of the second charging and discharging parking space 48 in the charging and discharging facility 20.

### DESCRIPTION OF EMBODIMENTS

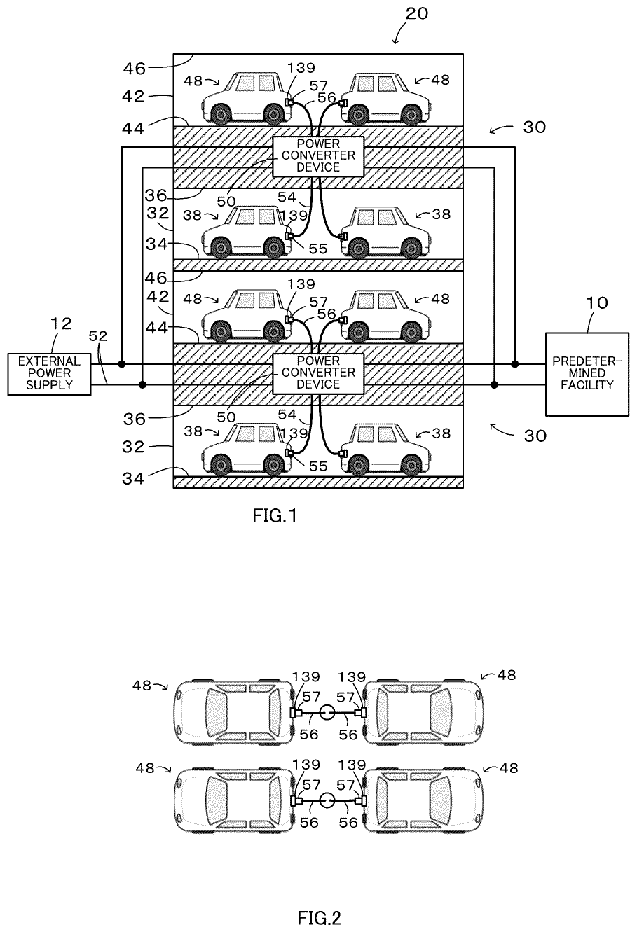

The following is a description of the embodiment of this disclosure (embodiment). FIG. 1 shows a schematic configuration of the charging and discharging facility 20 as one embodiment of this disclosure. FIG. 2 shows an illustration of an example of the arrangement of the second charging and discharging parking space 48 on the second floor of the charging and discharging facility 20.

The charging and discharging facility 20 of the embodiment is a four-story parking lot, as shown in FIG. 1. The parking lot is configured to stack two charging and discharging level sections 30. The two charging and discharging level sections 30 consist of a first level section 32 on the first floor and a second level section 42 on the second floor, and a first level section 32 on the third floor and a second level section 42 on the fourth floor.

The first level section 32 has a plurality of the first charging and discharging parking spaces 38, which can be used to park vehicles on the floor 34. The second level section 42 has a plurality of the second charging and discharging parking spaces 48, which can park vehicles on the floor 44, positioned directly above and aligned with the plurality of the first charging and discharging parking space 38 in the first level section 32.

Between the first level section 32 and the second level section 42, that is, between the ceiling 36 of the first level section 32 and the floor 44 of the second level section 42, there is the power converter device 50, which is connected to the external power supply 12 or the predetermined facility 10 by the power cable 52. The predetermined facility 10 will be described assuming an airport in the embodiment, but it can also be a large leisure facility with hotels, etc., a shopping center, a railroad station, a port, etc.

In the first charging and discharging parking space 38 of the first level section 32, for each vehicle, the first charging and discharging cable 54 connected to the power converter device 50 is arranged to extend from the ceiling 36. At the end of the first charging and discharging cable 54 is attached the first charging and discharging connector 55, which is connectable to the connector 139 on the vehicle side, which is connected to the battery mounted on the vehicle. In the first charging and discharging parking space 38, the first charging and discharging cable 54 is further extended by pulling the first charging and discharging connector 55, which is extended and hanging from the ceiling 36 by the first charging and discharging cable 54, connecting the first charging and discharging connector 55 to the connector 139 on the vehicle side, and then charging and discharging the battery mounted in the vehicle.

In the second charging and discharging parking space 48 of the second level section 42, for each vehicle, the second charging and discharging cable 56 connected to the power converter device 50 is arranged to extend out from the floor 44. At the end of the second charging and discharging cable 56 is attached the second charging and discharging connector 57, connectable to the connector 139 on the vehicle side, which is connected to the battery mounted on the vehicle. In the second charging and discharging parking space 48, the second charging and discharging connector 57, which is installed extending from the floor 44 by the second charging and discharging cable 56, is pulled to further extend the second charging and discharging cable 56 and connect the second charging and discharging connector 57 to the connector 139 on the vehicle side to charge and discharge the battery mounted in the vehicle.

The second charging and discharging parking space 48 in the second level section 42 is arranged so that two vehicles can be parked side by side in the front and rear directions, as shown in FIG. 2. The second charging and discharging cable 56 corresponding to each second charging and discharging parking space 48 is arranged to extend from the floor 44 between the two second charging and discharging parking spaces 48, where two vehicles can be parked side by side in the front and rear directions. The first charging and discharging cable 54 of the first level section 32 is arranged to extend from the ceiling 36 between the two first charging and discharging parking spaces 38, where two vehicles can be parked side by side in the front and rear directions, as would be the case if the floor 44 in the second charging and discharging parking space 48 in the second level section 42 were the ceiling 36, not shown.

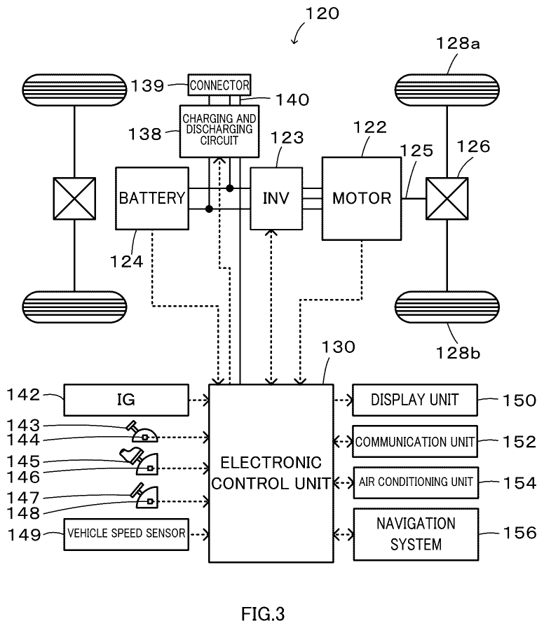

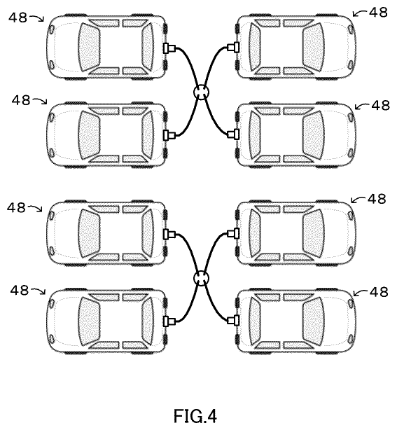

A vehicle that can use each of the charging and discharging parking spaces 38, 48 of the charging and discharging facility 20 of the embodiment can be, for example, the electric vehicle 120 illustrated in FIG. 3. The electric vehicle 120 is equipped with the motor 122, the inverter 123, the battery 124, the charging and discharging circuit 138, the connector 139, and the electronic control unit 130.

The motor 122 is configured, for example, as the synchronous generator motor. The rotor of the motor 122 is connected to the drive shaft 125 connected to the drive wheels 128a, 128b via the differential gear 126. The motor 122 is driven by three-phase AC power applied by the inverter 123 after DC power from the battery 124 is converted to three-phase AC power by the inverter 123. The battery 124 is configured as a well-known lithium-ion rechargeable battery or nickel-metal hydride rechargeable battery.

The charging and discharging circuit 138 is connected at one end to a power line connected to the battery 124 and at the other end to the connector 139 for connection to the first charging and discharging connector 55 or the second charging and discharging connector 57. The charging and discharging circuit 138 has the charging and discharging relay, which is not shown in the figure. The charging and discharging circuit 138 is connected to and disconnected from the battery 124 by the charging and discharging relay.

The electronic control unit 130 is configured as a microcomputer, which is mainly composed of a CPU, not shown in the figure. The electronic control unit 130 receives signals from various sensors via input ports. For example, the electronic control unit 130 inputs the ignition signal from the ignition switch 142, the shift position SP from the shift position sensor 144 that detects the position of the shift lever 143, the acceleration Acc from the accelerator pedal position sensor 146 that detects the amount of depressing the accelerator pedal 145, he brake position BP from the brake pedal position sensor 148 that detects the amount of depressing the brake pedal 147, and the vehicle speed V from the speed sensor 149. The electronic control unit 130 also inputs the rotation position θ from the rotation position sensor (not shown) that detects the rotation position of the motor 122, the battery voltage Vb from the voltage sensor (not shown) attached to the output terminal of the battery 124, the battery current Ib from the current sensor (not shown) attached to the output terminal of the battery 124, the charging and discharging voltage Vchg from the voltage sensor attached to the charging and discharging circuit 138, and the charging and discharging current Ichg from the current sensor attached to the charging and discharging circuit 138.

The electronic control unit 130 outputs various control signals via output ports. For example, the electronic control unit 130 outputs the display control signals to the display unit 150, the communication control signals to the communication unit 152, and the air conditioning control signals to the air conditioning unit 154. The electronic control unit 130 also outputs the switching control signals for switching the switching elements (not shown) to the inverter 123 to drive the motor 122, the drive control signals to the system main relay (not shown) mounted near the battery 124, and the drive control signal to the charging and discharging relay (not shown) attached to the charging and discharging circuit 138. The electronic control unit 130 communicates with the navigation system 156, which displays various information and provides route guidance. The electronic control unit 130 has the communication line 140 connected to the connector 139 to communicate with the power converter device 50 side when the first charging and discharging connector 55 or the second charging and discharging connector 57 is connected to the connector 139.

The battery 124 mounted on the electric vehicle 120 parked in each of the first charging and discharging parking spaces 38 of the first level section 32 and each of the second charging and discharging parking space 48 of the second level section 42 of the charging and discharging facility 20 of the embodiment function as a virtual power plant (VPP: Virtual Power Plant) capable of supplying power to the predetermined facility 10.

In the charging and discharging facility 20 of the embodiment described above, the power converter device 50 is placed between the first level section 32 and the second level section 42, connected by the power cable 52. In each of the first charging and discharging parking spaces 38 in the first level section 32, the first charging and discharging connector 55 is attached to the end of the first charging and discharging cable 54, which is connected to the power converter device 50 and extends from the ceiling 36. In each second charging and discharging parking space 48 in the second level section 42, the second charging and discharging connector 57 is attached to the end of the second charging and discharging cable 56, which is connected to the power converter device 50 and extends from the floor 44.

This allows for more effective use of space and reduces the wiring of power cables compared to those in which power converter devices are placed under the floor at each floor level and charging and discharging connectors are attached to the charging cables extending from the floor. As a result, the charging and discharging facility 20 in a multi-story parking lot is more efficient.

In the charging and discharging facility 20 of the embodiment, the first chargeable and discharging parking space 38 in the first level section 32 and the second chargeable and discharging parking space 48 in the second level section 42 are arranged so that two vehicles can be parked side by side in the front and rear directions. Then the charging and discharging cables 54, 56 corresponding to each of the charging and discharging parking space 38, 48 are arranged to extend from the ceiling 36 or floor 44 between the charging and discharging parking space 38, 48. However, as shown in the modified example in FIG. 4, the first charging and discharging parking spaces 38 in the first level section 32 and the second charging and discharging parking spaces 48 in the second level section 42 may be arranged so that they are arranged in two rows and two columns. In this case, the charging and discharging cables 54, 56 corresponding to each of the charging and discharging parking spaces 38, 48 may be arranged to extend from the ceiling 36 or floor 44 in the center of the two rows and two columns of the charging and discharging parking spaces 38, 48. In this way, the wiring of the 52 power cables can be further reduced and made more efficient.

In the charging and discharging facility 20 of the embodiment, the first charging and discharging parking space 38 in the first level section 32 and the second charging and discharging parking space 48 in the second level section 42 are configured as the charging and discharging parking space for the battery 124 mounted on the parked electric vehicle 120. However, the parking space may be configured as the parking space that allows only the charging of the battery 124 mounted on the parked electric vehicle 120 or configured as the parking space that allows only the discharging of the battery 124 mounted on the parked electric vehicle 120.

The charging and discharging facility 20 of the embodiment is a four-story parking lot that is configured to stack two charging and discharging level sections 30 consisting of a first level section 32 on the first floor and a second level section 42 on the second floor and a first level section 32 on the third floor and a second level section 42 on the fourth floor. However, it may be a two-tiered parking lot with only a single charging and discharging level section 30, or it may be a 6-level parking lot with 3 stacked the charging and discharging level sections 30, or it may also be a 2n-level parking lot with n stacked the charging and discharging level sections 30.

The charging and discharging facility 20 in the embodiment assume the electric vehicle 120 that runs by driving motor 122 using power from battery 124 as a chargeable and discharging parking space by parking in the first charging and discharging parking space 38 or the second charging and discharging parking space 48. However, since a vehicle can be equipped with a battery that can be charged and discharged, it can be a hybrid vehicle equipped with an engine, motor, and battery, or it can be a fuel cell vehicle equipped with a fuel cell and battery, it may also be a vehicle of various configurations, such as a fuel cell vehicle equipped with a fuel cell and a battery.

In the charging and discharging facility of the present disclosure, the two first charging and discharging parking spaces may be arranged to allow parking of two vehicles side-by-side in the front-back direction are located in the first level section, the two second charging and discharging parking spaces may be arranged to allow parking of two vehicles side-by-side in the front-back direction are located in the second level section so that the two first charging and discharging parking spaces are aligned with the two first charging and discharging parking spaces, the first charging and discharging cable may be arranged to extend from the ceiling between the two first charging and discharging parking spaces; and the second charging and discharging cable may be arranged to extend from the floor between the two second charging and discharging parking spaces. Also the four first charging and discharging parking spaces may be arranged in two rows and two columns are arranged in the first level section, the four second charging and discharging parking spaces arranged in two rows and two columns may be arranged in the second level section so as to be aligned with the four first charging and discharging parking spaces, the first charging and discharging cable may be arranged to extend from the center ceiling of the four first charging and discharging parking spaces; and the second charging and discharging cable may be arranged to extend from the floor in the center of the four second charging and discharging parking spaces. In this way, the charging and discharging facility can be made more efficient.

In the charging and discharging facility of the present disclosure, the charging and discharging hierarchical sections, consisting of the first level section and the second level section, may be arranged in a plurality of planar or three-dimensional arrays.

The following is an explanation of the correspondence between the main elements of the embodiment and the main elements of the embodiment described in the section on means to solve the problem. In the embodiment, the first charging and discharging parking space 38 corresponds to “the first charging and discharging parking space”, the first level section 32 corresponds to “the first level section”, the second charging and discharging parking space 48 corresponds to “the second level parking space”, the second level section 42 corresponds to “the second level section”, the power converter device 50 corresponds to “the power converter device”, the connector 139 corresponds to “the vehicle-side connection”, the first charging and discharging connector 55 corresponds to “the first charging and discharging connection member”, the first charging and discharging cable 54 corresponds to “the first charging and discharging cable”, the second charging and discharging connector 57 corresponds to the “the second charging and discharging connection member”, the second charging and discharging cable 56 corresponds to the “the second charging and discharging cable”.

The correspondence between the major elements of the embodiment and the major elements of the embodiment described in Summary is an example of how the embodiment can be used to specifically explain the embodiment of the disclosure described in Summary. This does not limit the elements of the disclosure described in Summary. In other words, interpretation of the disclosure described in Summary should be based on the description in that section, and the embodiment is only one specific example of the disclosure described in Summary.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure can be used in the charging and discharging facility manufacturing industry, for example.

What is claimed is:

1. A charging and discharging facility comprising:
a first level section in which a first charging and discharging parking space is located for charging and discharging a battery mounted on a vehicle;
a second level section, which is a floor directly above the first level section arranged such that a second charging and discharging parking space for charging and discharging a battery mounted on the vehicle is located directly above the first charging and discharging parking space; and
a power converter device located between the first level section and the second level section and connected to the outside world by a power cable; wherein
in the first charging and discharging parking space, a first charging and discharging connection member that is chargeable and dischargeable with a vehicle-side connection for charging and discharging the battery of a parked vehicle is attached to the end of a first charging and discharging cable that is connected to the power converter device and extends from a ceiling of the first level section; and
in the second charging and discharging parking space, a second charging and discharging connection member that is chargeable and dischargeable with a vehicle-side connection for charging and discharging the battery of the parked vehicle is attached to the end of a second charging and discharging cable that is connected to the power converter device and extends from a floor of the second level section.

2. The charging and discharging facility according to claim 1, wherein the two first charging and discharging parking spaces arranged to allow parking of two vehicles side-by-side in the front-back direction are located in the first level section;
the two second charging and discharging parking spaces arranged to allow parking of two vehicles side-by-side in the front-back direction are located in the second level section such that the two first charging and discharging parking spaces are aligned with the two first charging and discharging parking spaces;
the first charging and discharging cable is arranged to extend from the ceiling between the two first charging and discharging parking spaces; and
the second charging and discharging cable is arranged to extend from the floor between the two second charging and discharging parking spaces.

3. The charging and discharging facility according to claim 1, wherein the four first charging and discharging parking spaces arranged in two rows and two columns are arranged in the first level section;
the four second charging and discharging parking spaces arranged in two rows and two columns are arranged in the second level section so as to be aligned with the four first charging and discharging parking spaces;
the first charging and discharging cable is arranged to extend from the center ceiling of the four first charging and discharging parking spaces; and
the second charging and discharging cable is arranged to extend from the floor in the center of the four second charging and discharging parking spaces.

4. The charging and discharging facility according to claim 1, wherein a charging and discharging hierarchical sections, consisting of the first level section and the second level section, are arranged in a plurality of planar or three-dimensional arrays.

5. The charging and discharging facility according to claim 2, wherein a charging and discharging hierarchical sections, consisting of the first level section and the second level section, are arranged in a plurality of planar or three-dimensional arrays.

6. The charging and discharging facility according to claim 3, wherein a charging and discharging hierarchical sections, consisting of the first level section and the second level section, are arranged in a plurality of planar or three-dimensional arrays.
